(19) United States
(12) Patent Application Publication
(10) Pub. No.: US 2002/0003410 A1
(43) Pub. Date: Jan. 10, 2002

(54) WINDSHIELD WIPER INTENDED FOR A MOTOR VEHICLE

(76) Inventor: HANS-PETER LASSLE, USINGEN (DE)

Correspondence Address: MARTIN A FARBER, SUITE 473, 866 UNITED NATIONS PLAZA, NEW YORK, NY, 10017

(21) Appl. No.: 09/391,837

(22) Filed: Sep. 8, 1999

(30) Foreign Application Priority Data
Sep. 19, 1998 (DE) 198 43 050.7

(51) Int. Cl. H02P 1/00

(52) U.S. Cl. 318/445

(57) ABSTRACT

In the case of a windshield wiper (1) which is intended for a motor vehicle and has a wiper motor (2), whose rotational speed is monitored, and a control element (10) for stipulating a desired wiping mode, sensors (4, 5, 6, 7) for detecting environmental influences are provided, which sensors are connected to a controlling means (8) for generating a rotational-speed command as a function of these environmental influences.

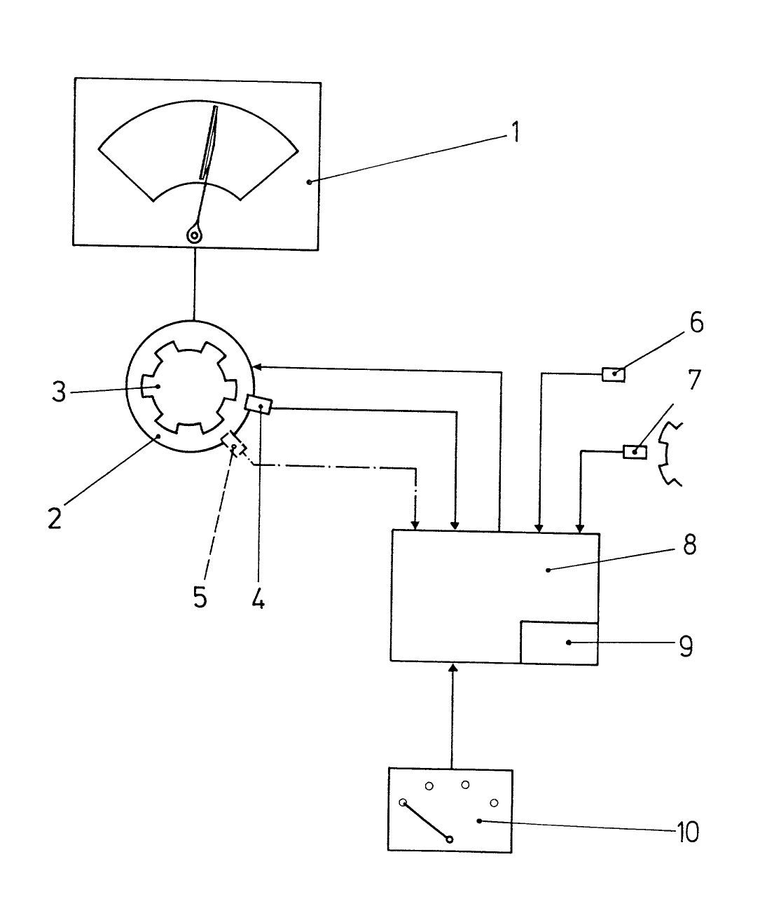

The invention relates to a windshield wiper which is intended for a motor vehicle and has a wiper motor, whose rotational speed is monitored, and has a control element for stipulating a desired wiping mode and also a controlling means which is connected between the control element and the wiper motor and is intended for controlling the rotational speed of the wiper motor on the basis of sensor signals.

Windshield wipers of the type mentioned above are known. Compared with customary windshield wipers they have the advantage that relatively large fluctuations in the speed of the windshield wipers are avoided during the wiping operation. Such changes in speed occur, for example, due to different frictional conditions, because wetting of the windshield differs, or due to the design of the wiper mechanism. Motor vehicle users generally find the changes in speed to be annoying.

The known windshield wiper is controlled in such a manner that the wiper speed, which is input via the control element, is kept constant even under different conditions. The driver therefore has to decide which wiper speed is in each case appropriate. This requires precise observation of the wiping procedure and therefore distracts the driver from what is happening on the road. In practice, the environmental influences, which have a determining influence on the wiping procedure, often change very rapidly and frequently, for example when overtaking a truck during rain, so that the driver has to adjust the wiper speed relatively often at the control element.

The invention is based on the problem of designing a windshield wiper which is intended for a motor vehicle, in such a manner that its wiping speed automatically adapts to different environmental influences.

According to the invention, this problem is solved in that the sensors are designed for detecting environmental influences, and the controlling means is designed for generating a rotational-speed command as a function of these environmental influences.

With a windshield wiper of this type, the wiping speed is able to adapt to different environmental influences irrespective of the driver's stipulations. As a result, the driver no longer has to watch to see whether the wiper result is optimum and so is not distracted by this from what is happening on the road. Furthermore, the driver does not have to decide for himself which wiping speed is optimum in each case, because the wiper electronics become an intelligent system through the invention. The driver is additionally relieved from adjusting the wiper speed during the journey since the windshield wiper, because of the sensors for detecting environmental influences, becomes an adaptive system.

It is particularly advantageous if the controlling means is connected to a sensor for detecting the speed of the motor vehicle. Increasing speed inevitably leads to an increase in the number of raindrops falling against the windshield per unit of time, and so the invention means that the wiper speed then automatically increases. Furthermore, with such a controlling means the fact that the contact-pressure force of the windshield wipers against the windshield changes with the speed of the motor vehicle, because of wind action, can be taken into account.

The wiping-speed increase which is required with increasing rain can also be achieved by the controlling means being connected to a sensor for detecting the heaviness of rain.

Up to now, in order to detect the rotational speed of wiper motors, the current consumption of said motors has been determined, but this resulted in a comparatively imprecise control. Since in the meantime rotational-speed sensors which operate very precisely and are obtainable at good value are customary for the rotational-speed monitoring of the vehicle wheels, for the rotational-speed monitoring of windshield wiper motors it is likewise advantageous if the wiper motor has an increment generator for detecting its rotational speed and/or for detecting the position of the windshield wiper. This detection of the travel of the windshield wiper makes it possible for the speed of the windshield wiper to be controlled with high precision.

A windshield wiper can be controlled with respect to its wiping speed in a particularly optimum manner if, according to another development of the invention, the controlling means has a memory storing characteristic data with travel-time diagrams for generating desired values for the speed of the windshield wiper.

The invention permits various embodiments. To further clarify its basic principle one of these embodiments is illustrated schematically in the drawing as a block diagram and is described below.

The drawing shows a windshield wiper 1 which is driven by a wiper motor 2. The wiper motor 2 has a toothed disk 3 which rotates synchronously with it and whose rotations are detected by a sensor 4, which can be an increment generator, for example, a Hall sensor. A position sensor 5, which can monitor the position of the windshield wiper 1 as an alternative to the rotational-speed detection, has been shown by dashed lines. The arrangement may have further sensors, for example, a sensor 6 for monitoring the ambient temperature or a sensor 7 for monitoring the travelling speed of the motor vehicle which has the windshield wiper 1.

The signals of the sensors 4, 5, 6, 7 are fed to a controlling means 8 which can have a memory 9 storing characteristic data.

To use the windshield wiper 1, the driver switches a control element 10 to the wiping mode which he desires, i.e., for example, to a certain wiping speed with defined intermittent interruptions. The controlling means 8 then activates the wiper motor 2, so that the latter starts up. The sensor 4 measures the particular rotational speed of the wiper motor 2 and increases the electric voltage supplied to it if the rotational speed falls below the desired value. In addition, however, the controlling means 8 also processes the signals of the sensors 6 and 7, which monitor the environment influences, and, if appropriate, the signals of further sensors. If it is gathered from these sensor signals that the wiping speed has to be increased, this is then raised irrespective of the driver stipulations. From the control stipulation and the sensor signals, a desired-value generator generates a desired value which is processed by the controlling means.

If time-travel diagrams, which reproduce the sequence of the windshield-wiper position from the zero position through the maximum deflection back again to the zero position, are stored in the memory 9 storing characteristic data, the controlling means 8 then controls the windshield wiper 1 in accordance with these travel-time diagrams. Since the curve profile of these diagrams can be defined as desired, such diagrams can be used to ensure an optimum wiper result.

1. A windshield wiper which is intended for a motor vehicle and has a wiper motor, whose rotational speed is monitored, and has a control element for stipulating a desired wiping mode and also a controlling means which is connected between the control element in the wiper motor and is intended for controlling the rotational speed of the wiper motor on the basis of sensor signals, wherein the sensors (4, 5, 6, 7) are designed for detecting environmental influences, and the controlling means (8) is designed for generating a rotational-speed command as a function of these environmental influences.

2. The windshield wiper as claimed in claim 1, wherein the controlling means (8) is connected to a sensor (4) for detecting the speed of the motor vehicle.

3. The windshield wiper as claimed in claim 1, wherein the controlling means (8) is connected to a sensor for detecting the heaviness of rain.

4. The windshield wiper as claimed in at least one of the preceding claims, wherein the wiper motor (2) has a sensor (5), which is designed as an increment generator, for detecting the position of the windshield wiper (1) and/or for detecting its rotational speed.

5. The windshield wiper as claimed in at least one of the preceding claims, wherein the controlling means (8) has a memory (9) storing characteristic data with travel-time diagrams for generating desired values for the speed of the windshield wiper (1).
